(19) United States
(12) Patent Application Publication
(10) Pub. No.: US 2008/0228910 A1
(43) Pub. Date: Sep. 18, 2008

(54) METHOD FOR MONITORING USER INTERACTION TO MAXIMIZE INTERNET WEB PAGE REAL ESTATE

(75) Inventor: John E. Petri, Lewiston, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/684,793

(22) Filed: Mar. 12, 2007

(51) Int. Cl. G06F 15/173

(52) U.S. Cl. 709/224

(57) ABSTRACT

A method for rendering Internet Web page content for a client, includes: setting client based policies with a plug-in; monitoring client based Internet Web page usage and interaction with the plug-in or Web page; determining whether a client policy exists for a particular Internet Web page; verifying whether a server-side application is configured for screen management; wherein whenever the server-side application is configured for screen management the plug-in sends the client policy to the server-side application; and in the event the server-side application is returning enhanced content to the client, the enhanced content is altered on the server-side application based on the client policy and then sent to the client.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to software, and more particularly to providing a method and system for monitoring a user's Internet Web browsing/page interaction over time to maximize Internet web page real estate.

2. Description of the Related Art

The Internet has become a central source of news and entertainment for an increasing segment of the population. The amount of content offered on the Internet has increased as well. Internet users are constantly looking for more efficient ways to view information on the Internet, and in particular increasing the user's viewable area within a web browser. For example, the latest browsers have been shrinking (or as in the case with Microsoft's Internet Explorer 7, eliminating) toolbars and status areas in order to provide the user with additional screen space. As a consequence of the reduction or elimination of toolbars and status area, the user has more room on their screen to read articles, look at additional pictures, watch larger sized videos, etc. However, it is not always the browser that produces unnecessary clutter on the screen. Websites can often be at fault, providing banners, navigation buttons, footers, sidebars, etc. In many instances this information is extraneous. For example, all sorts of extra content, including navigation menus, sidebars, and links to related articles often surround news articles. In cases where the user never selects the extra content (for example, the user clicks a headline link, reads the article, and then presses “back” on the browser when done), it would be useful if the user did not also have to spend additional time scrolling past extra content to read the selected article. On the other hand, there may be other users who are in fact interested in viewing/clicking on the extra content. Therefore, there is a need to monitor a user's Web browsing activity over time to determine which Web page elements the user does or does not interact with, and subsequently hide unused elements when rendering the page for the user.

Solutions exist today that allow users to apply custom scripts to remove unwanted “annoyances” from Web sites (e.g., for blocking banner ads, disabling scripts, etc.). However, there are certain drawbacks associated with the user scripts. Firstly, it is a manual process. If the user is annoyed by something on a website they either need to write their own script, search for an existing script, or request to have someone create a script for them. In many instances, the same things might not annoy other users; for example, 90% of users may not object to the extra navigation content, so there is no need for the development community to create scripts for that site. If the user is not “software savvy,” they could have a difficult time obtaining scripts. Secondly, user scripts need to be created uniquely for each site. A possible exception to this is Adblock that is being developed by a community of software developers referred to as mozdev.org. Adblock allows the user to specify regular expressions for matching content, however users have noted that Adblock does not match on all web sites. Also, website tracking software exists to determine website statistics such as page hits. However, Web tracking does not monitor user interaction with individual elements on the page.

### SUMMARY OF THE INVENTION

Embodiments of the present invention include a method and system for rendering Internet Web page content for a client, wherein the method includes: setting client based policies with a plug-in or Web page; monitoring client based Internet Web page usage and interaction with the plug-in; determining whether a client policy exists for a particular Internet Web page; verifying whether a server-side application is configured for screen management; wherein whenever the server-side application is configured for screen management the plug-in sends the client policy to the server-side application; in the event the server-side application is returning enhanced content to the client, the enhanced content is altered on the server-side application based on the client policy and then sent to the client.

A system for rendering Internet Web page content based on client usage of page elements, the system includes: one or more server devices in communication with one or more client devices through a network; the server devices and the client devices configured to execute electronic software that manages the Internet Web page rendering; wherein the electronic software is resident on storage mediums in signal communication with the client and server devices; wherein the electronic software provides a plug-in or Web page for setting client based policies; wherein the electronic software monitors client based Internet Web page usage and interaction with the plug-in; wherein the electronic software determines if a client policy exists for a particular Internet Web page; wherein the electronic software verifies whether a server-side application is configured for screen management; wherein whenever the server-side application is configured for screen management the plug-in sends the client policy to the server-side; and wherein in the event the server-side is returning enhanced content to the client, the enhanced content is altered on the server-side application based on the client policy and then sent to the client.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for monitoring a user's Internet Web browsing/page interaction over time to determine winch Web page elements the user has interacted with most often, and subsequently hides rarely used elements when rendering the page. By tracking individual user interactions over time the summarized invention has the ability to dynamically alter Web page content.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A-1C are a flow diagram illustrating a method for monitoring Web page usage and Web page rendering from both the client and server side according to an embodiment of the invention.

FIG. 2 is a flow diagram illustrating a method of monitoring Web page usage based on user actions on a Web page and the updating of a policy database according to an embodiment of the invention.

FIGS. 3A and 3B are flow diagrams relating to collapsible elements on the client side according to an embodiment of the invention.

FIG. 4 illustrates a system for implementing embodiments of the invention.

The detailed description explains the preferred embodiments of the invention, together with advantages and features, by way of example with reference to the drawings.

### DETAILED DESCRIPTION

Embodiments of the invention provide a means for monitoring a user's Web browsing/page interaction over time to determine which Web page elements the user has interacted with most often, and subsequently hides rarely used elements when rendering the page. By tracking individual user interactions over time the embodiments of the invention have the ability to dynamically alter Web page content.

Embodiments of the invention are comprised of both a client side application and a server side application.

The client side application (e.g., browser plug-in or collection of scripts) monitors the user's interaction with Web pages. For example, the client side application can track mouse movement/hover time and/or mouse clicks that are targeted at elements on the page. The client side application then stores this usage history in a database. Each time the user visits the Web page; the database is updated with usage information. The client side application can be configured (either generally or per site) with thresholds to determine when rarely used elements on the page should be hidden by the client side application. If the client side application determines that elements on the page are to be hidden, it dynamically alters the page source when rendering to increase the page's viewable screen size. This approach personalizes Web page rendering on a per user basis.

In addition to providing a client side application, a website can choose to participate in a server-side monitoring service, whereby usage data can be sent continuously via Asynchronous JavaScript (AJAX), or another similar asynchronous technology, to the Web server. This can enhance user experience on the website by allowing for more generalized usage profiles to be established. For example, if 90% of users on a particular website do not use the navigation menu when viewing news, the Web server system may determine that by default the navigation menu should be hidden. In addition, a particular website may wish to tailor their content based on more or less screen real estate as dictated by user history. Based on the user history, the site could send more or larger images when the user has considerably more Web browser screen real estate.

Unlike previous attempts at scripting that provide a means for dynamically altering page content, embodiments of the present invention have the advantage of taking into account the user's interaction history to provide an automated means to maximize the user's Web browser screen real estate for any Web page.

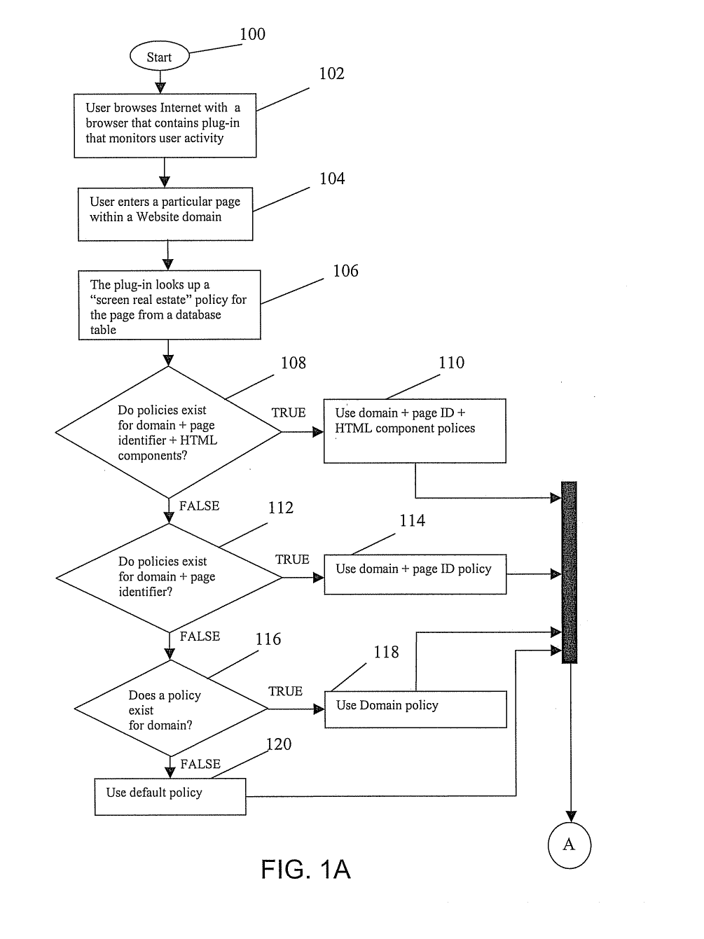

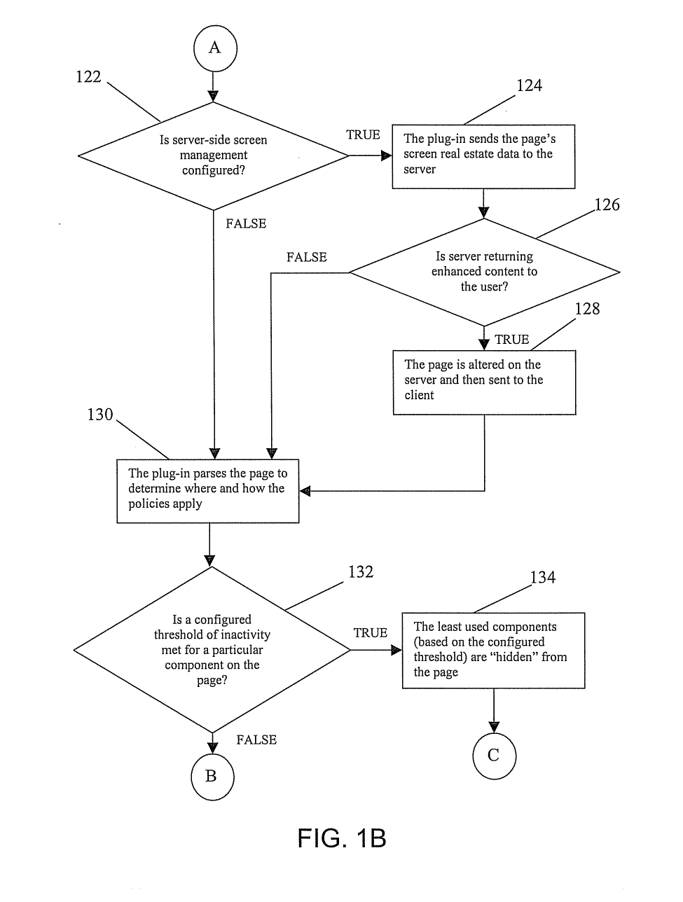

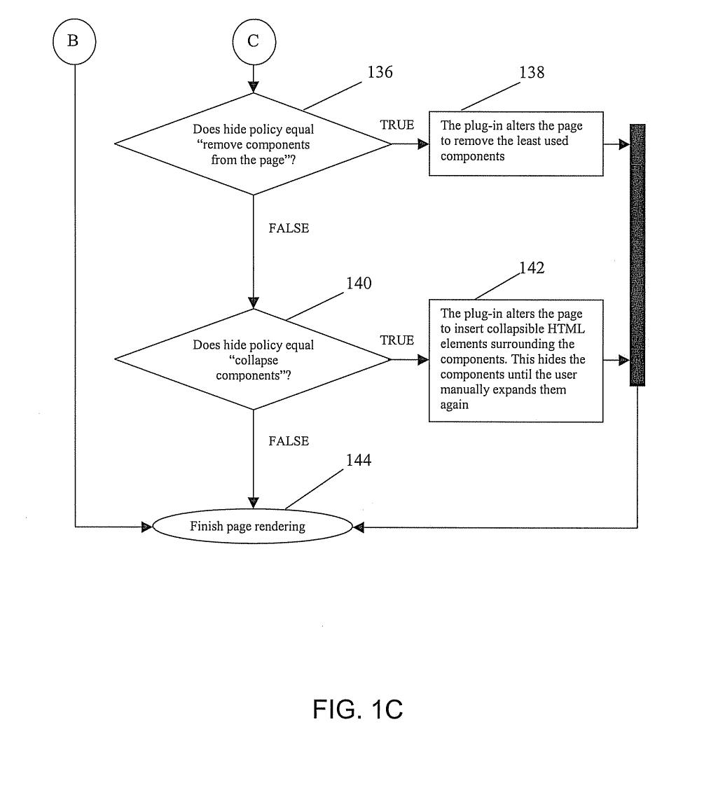

FIGS. 1A-1C are a flow diagram illustrating a method for monitoring Web page usage and Web page rendering from both the client and server side according to an embodiment of the invention. The method starts 100 with a user browsing the Internet with a browser that contains a plug-in that monitors user activity (102). When a user enters a particular Web page within a website domain (104) the plug-in looks Up a “screen real estate” policy for the page from a database table (106). Examples of policies for “screen real estate” are for domain, page identifier, and Hyper Text Markup Language (HTML) components. It will be noted that if policies are configured at the HTML component level, there may be more than one policy in use, since a Web page is made up of several HTML components. Based on the combination of policies in use, the client side browser makes decisions (108, 112, 116) to use the policies (110, 114, 118) or a default policy 120 that is sent to the server side. Progressing to FIG. 1B, if the server side is configured for screen management (122) the client side browser plug-in sends the Web page's screen real estate data to the server (124). The server evaluates the screen real estate data to determine if it should return enhanced content (e.g. larger/higher resolution images) to the user (126). If the server is returning enhanced content, the Web page is altered on the server and then sent to the client (128). If the server is not configured for screen management, the Web browser plug-in parses the Web page to determine where and how the policies apply (130).

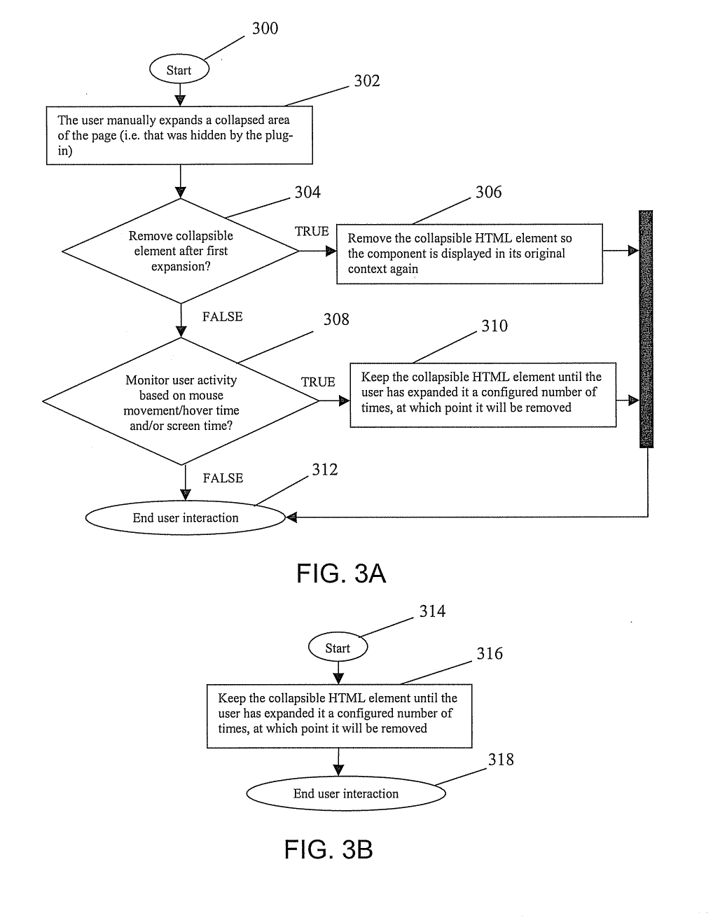

The Web browser determines via the policy if a configured threshold for inactivity has been met for particular components on the Web page (132). If the inactivity threshold has not been met, the web page is rendered (144) as is on the user Web browser display (see FIG. 1C). However, if the inactivity threshold has been met, the least used components are “hidden” from the Web page (134). As described in FIG. 3C, the hide policy can either require the removal of the components from the Web page (136) in which case the plug-in alters the Web page to remove the least used components (138), or to hide components by “collapsing” them (140). In order to collapse components, the plug-in alters the Web page by inserting collapsible HTML elements surrounding the components, which act to hide the components until the user manually expands them again (142). The page is then rendered (144).

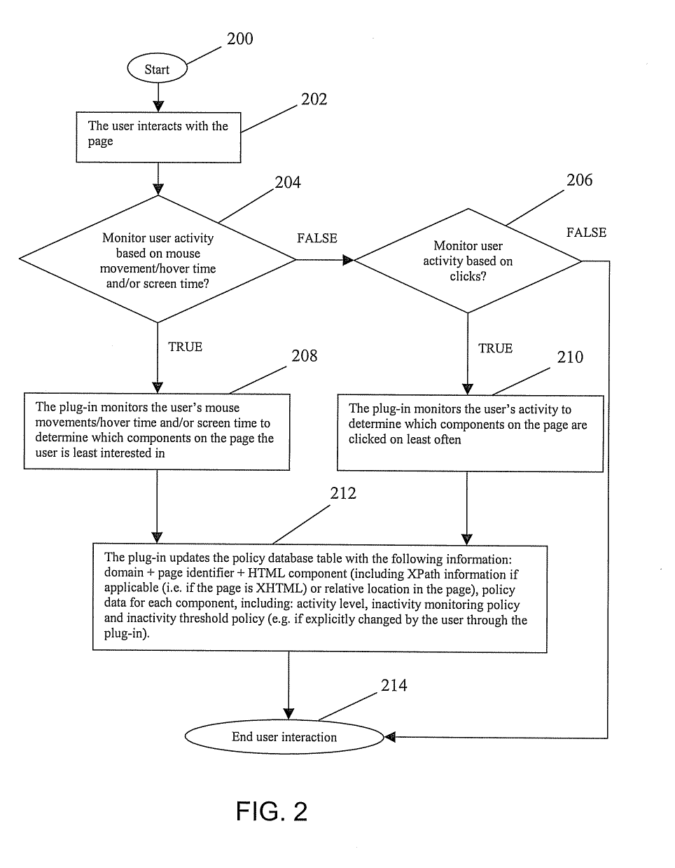

FIG. 2 is a flow diagram illustrating a method of monitoring Web page usage based on user actions on a Web page and the updating of a policy database according to an embodiment of the invention. The method starts 200 with the user interacting with the Web page (202). The plug-in monitors user activity based on mouse movement/hover time, and/or screen time (204) and determines which components on the page the user is least interested in (208), where screen time for a particular area of the Web page is determined by how long that area is within the visible pane of the browser, or by activity based on user selection clicks (206) to determine which components on the page are clicked on least often (210). The combination of hover time and screen time is determined by the policy (e.g., one or the other, or both may be used). Hover time and screen time is useful for areas of a Web page, which may not contain clickable/linkable elements, but take up space and are rarely used. The monitoring of mouse movement/hover time/screen time within these areas can give an indication of how much the user is interested in a particular area. The plug-in updates the policy database table (212) with the following information: domain+page identifier+HTML component (including XPath information if applicable (i.e. if the page is XHTML) or relative location in the page), policy data for each component, including: activity level, inactivity monitoring policy and inactivity threshold policy (e.g. if explicitly changed by the user through the plug-in). It should be noted that this information may be updated in real time or when the user exits the Web page. User interaction ends (214) whether or not activity is monitored.

FIGS. 3A and 3B are flow diagrams relating to collapsible elements on client side according to an embodiment of the invention. The user starts 300 to manually expand a collapsed area of the Web page that was hidden by the plug-in (302). Based on the user's selection, the plug-in can remove the collapsible element after this first expansion (304), thus removing the collapsible HTML element so the component is displayed in its original context again (306). However, the plug-in may continue to monitor user activity based on mouse movement, hover time, and/or screen time to determine when to remove the collapsible HTML element (308). The collapsible HTML element is kept until the user has expanded the collapsed area a predetermined number of times, at which point it will be removed (310). User interaction ends at 312. In another embodiment (see FIG. 3B), the user interaction starts (314) and the collapsible HTML element is kept until the user has expanded the collapsed area of the Web page a predetermined (configured) number of times as recorded by the plug-in, at which point the collapsible HTML is removed (316). User interaction ends at 318.

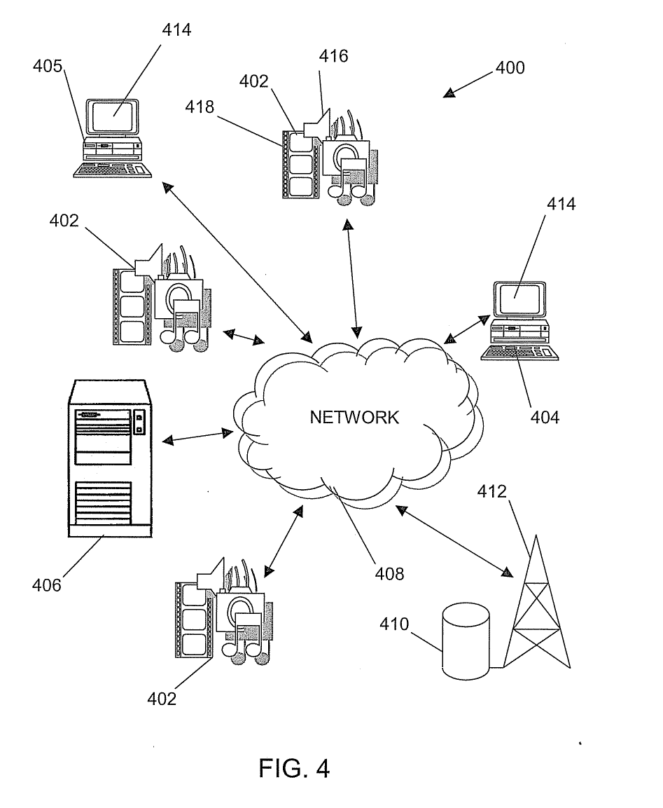

FIG. 4 is a block diagram of an exemplary system 400 for implementing the Web page interaction elements of the present invention and graphically illustrates how those blocks interact in operation. The system 400 includes remote devices including one or more multimedia/communication devices 402 equipped with speakers 416 for implementing audio, as well as display capabilities 418 for facilitating the graphical user interface (GUI) and Web browsing aspects of the present invention. In addition, mobile computing devices 404 and desktop computing devices 405 equipped with displays 414 for use with the GUI and Web browsers of the present invention are also illustrated. The remote devices 402 and 404 may be wirelessly connected to a network 408. The network 408 may be any type of known network including a local area network (LAN), wide area network (WAN), global network (e.g., Internet), intranet, etc. with data/Internet capabilities as represented by server 406. Communication aspects of the network are represented by cellular base station 410 and antenna 412. Each remote device 402 and 404 may be implemented using a general-purpose computer executing a computer program for carrying out embodiments of the navigational control described herein.

The computer program may be resident on a storage medium local to the remote devices 402 and 404, or maybe stored on the server system 406 or cellular base station 410. The server system 406 may belong to a public service. The remote devices 402 and 404, and desktop device 405 may be coupled to the server system 406 through multiple networks (e.g., intranet and Internet) so that not all remote devices 402, 404, and desktop device 405 are coupled to the server system 406 via the same network. The remote devices 402, 404, desktop device 405, and the server system 406 may be connected to the network 408 in a wireless fashion, and network 408 may be a wireless network. In an exemplary embodiment, the network 408 is a LAN and each remote device 402, 404 and desktop device 405 executes a user interface application (e.g., web browser) to contact the server system 406 through the network 408. Alternatively, the remote devices 402 and 404 may be implemented using a device programmed primarily for accessing network 408 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for rendering Internet Web page content for a client, wherein the method comprises:
setting client based policies with a plug-in or Web page;
monitoring client based Internet Web page usage and interaction with the plug-in;
determining whether a client policy exists for a particular Internet Web page;
verifying whether a server-side application is configured for screen management;
wherein whenever the server-side application is configured for screen management the plug-in sends the client policy to the server-side; and
in the event server-side application is returning enhanced content to the client, the enhanced content is altered on the server-side application based on the client policy and then sent to the client.

2. The method of claim 1, wherein in the event the server-side is not configured for screen management the plug-in parses the Internet Web page to determine where and how the policies apply.

3. The method of claim 1, wherein client based policies comprise domain information, page identifiers, HTML components, and screen real estate.

4. The method of claim 1, wherein in the event a configured threshold of inactivity policy has been met for a particular component on the Internet Web page, the component is hidden from the page for subsequent renderings; and
wherein the inactivity policy alters the page to remove the least used components.

5. The method of claim 4, wherein the inactivity policy alters the page by inserting collapsible HTML elements surrounding the particular component; and
wherein the collapsible HTML elements hide the particular components until the client manually expands them again.

6. The method of claim 5, wherein whenever the client expands the particular components the collapsible HTML elements are removed after the first expansion.

7. The method of claim 5, wherein whenever the client expands the particular components the collapsible HTML elements are kept in place for a configured number of expansions until removal by the plug-in.

8. The method of claim 1, wherein the monitoring of client based Internet Web page usage and interaction is comprised of at least one of the following: mouse movement, hover time, and screen time;
wherein based on the monitoring the plug-in determines which components on the page the client is least interested in; and
wherein the plug-in updates a policy database table based on the monitoring.

9. The method of claim 1, wherein the monitoring of client based Internet Web page usage and interaction is based on selection clicks;
wherein based on the monitoring the plug-in determines which components on the page are clicked on least often; and
wherein the plug-in updates a policy database table based on the monitoring.

10. A system for rendering Internet Web page content based on client usage of page elements, the system comprising:
one or more server devices in communication with one or more client devices through a network;
the server devices and the client devices configured to execute electronic software that manages the Internet Web page rendering;
wherein the electronic software is resident on storage mediums in signal communication with the client and server devices;
wherein the electronic software provides a plug-in or Web page for setting client based policies;
wherein the electronic software monitors client based Internet Web page usage and interaction with the plug-in;
wherein the electronic software determines if a client policy exists for a particular Internet Web page;
wherein the electronic software verifies whether a server-side application is configured for screen management;
wherein whenever the server-side application is configured for screen management the plug-in sends the client policy to the server-side; and
wherein in the event the server-side is returning enhanced content to the client, the enhanced content is altered on the server-side application based on the client policy and then sent to the client.

11. The system of claim 10, wherein in the event the server-side is not configured for screen management the plug-in parses the Internet Web page to determine where and how the policies apply.
